(19) United States
(12) Patent Application Publication
(10) Pub. No.: US 2002/0144157 A1
(43) Pub. Date: Oct. 3, 2002

(54) Method and apparatus for security of a network server

(75) Inventors: Yanchun Zhao, Toronto (CA); Qi Cheng, Toronto (CA)

Correspondence Address: Gerald R. Woods, IBM Corporation T81/503, PO Box 12195, Research Triangle Park, NC, 27709, US

(73) Assignee: International Business Machines Corporation, Armonk, NY (US)

(21) Appl. No.: 10/084,567

(22) Filed: Feb. 27, 2002

(30) Foreign Application Priority Data
Mar. 29, 2001 (CA) 2342578

(51) Int. Cl. G06F 11/30

(52) U.S. Cl. 713/201; 709/223

(57) ABSTRACT

A method, apparatus and software is provided for protecting security of a network or Internet server from unauthorized content contained in a message received by the server from a user, which provide the capability of intercepting the message received before any content of the message is processed by the server; examining the message received to determine if it contains one or more unauthorized elements. If it is determined that the message contains an unauthorized element, steps are take to prevent the message from being processed by the server. If it is determined that the message does not contain an unauthorized element, the message is allowed to be processed by the server.

### FIELD OF THE INVENTION

The invention relates to network security, and in particular to a method and apparatus for protecting network servers from unauthorized access to server resources by users

### BACKGROUND OF THE INVENTION

With the expansion of the Internet, more and more companies have moved their business operations to the Internet. Many companies, such as merchants have established web sites from which they conduct business transactions. These are called e-commerce sites. By allowing customers to access these e-commerce sites over the Internet the customers can do transactions with these companies over the Internet, using web browsers running on the customers' computers or other Internet access devices.

Typically an e-commerce site consists of a web server for creating a connection to the Internet which passing information to and from the Internet, an application server connected to the web server for processing information and a database accessible by the application server. The database ordinarily contains important information of the company represented by the site. The information can include, for instance, inventory levels, customer information, supplier information, accounting information, credit card information, and other sensitive information necessary for the continued operation of the company. This information tends to be quite valuable, and thus poses a great temptation to unscrupulous people. It is thus extremely important to protect the information in the database to prevent the unauthorized or malicious access to the database.

An application tool (a dynamic page generator) at the e-commerce site is normally used to generate a dynamic web page accessible by a customer over the Internet for use in making a request or placing an order. The customer's browser causes a representation of the web page to be displayed on a display at the customer's computer or web access device. The customer can enter information and make requests by inserting information into appropriate text boxes or check boxes on the representation of the web page. When the customer is satisfied with the completion of a web page and submits the information or request to the e-commerce site, the browser of the customer generates name pair values (NPV's) corresponding to the information and requests made by the customer to the e-commerce site.

The web server at the e-commerce site passes these NPV's to the application server in which one or more application tools are used to process the NPV's in order to satisfy the customer's requests. The processing usually requires accessing the database associated with the application server.

It has been learned that unscrupulous users have developed techniques concealing unauthorized instructions in normal orders and other submissions to e-commerce servers in order access unauthorized resources or perform unauthorized or destructive tasks.

### SUMMARY OF THE INVENTION

The invention provides method and apparatus for blocking unauthorized instructions to help prevent access by unauthorized users to server resources.

One aspect of the invention is a method of securing a network server from unauthorized content contained in a message received by the server from a user, including intercepting the message received before any content of the message is processed by the server; examining the message received to determine if it contains one or more unauthorized elements; if it is determined that the message received contains an unauthorized element preventing the message received from being processed by the server. If it is determined that the message received does not contain an unauthorized element, the message is allowed to be processed by the server.

If it is determined that the message received contains an unauthorized element, an error notification may be sent to the user.

Preferably the method includes the step of identifying an execution program set to be used to process the message received; retrieving identification of all message types associated with the execution program set; examining the message received by the server in relation to the message types associated with the execution program set; determining if the message received by the server contains an unauthorized element in relation to the corresponding message type for the message received; and, preventing a received message containing an unauthorized element from being processed by the server. An error notification can be sent to the user or to an administrator of the server.

A message can include a name-value pair as is commonly understood in data processing.

The element comprises one or more of the following items: an instruction, a command, a character, a parameter, a token, or a string of any of the previous items. The element could be something that is interpretable as an instruction or command by the server.

The invention can be implemented by a computer program including program routines for carrying out the steps of the method of the invention described above.

### BRIEF DESCRIPTION OF THE DRAWINGS

The accompanying drawings, illustrate an embodiment of the invention and together with the description assist in the explanation of the advantages and principles of the invention; in which:

FIG. 1 is a block diagram illustrating an Internet e-commerce network including an e-commerce server employing an embodiment of the security apparatus of the present invention;

FIG. 2 depicts a web page, having text boxes and check boxes for entering information, as represented to a customer by the customer's web browser;

FIG. 3 is a flow diagram illustrating the method of operation of the invention in an e-commerce server employing an embodiment of the security apparatus of the present invention.

### DETAILED DESCRIPTION OF THE PREFERRED EMBODIMENTS OF THE INVENTION

Many merchant companies have established web sites on networks such as the Internet from which they conduct business transactions with customers, to sell wares or services. These merchant web sites are sometimes referred to as e-commerce sites.

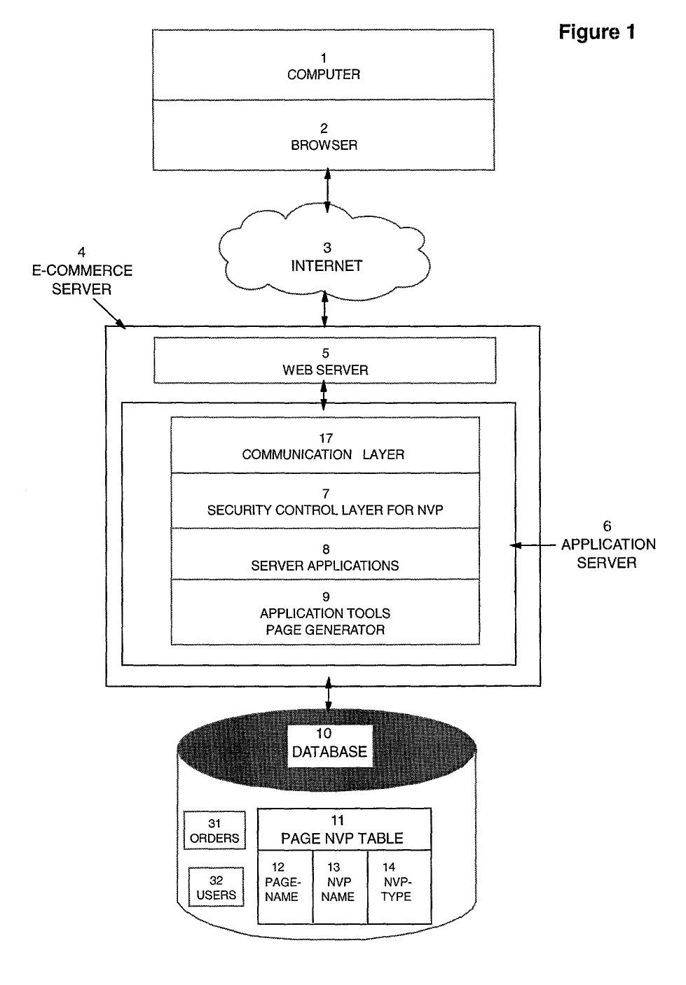

FIG. 1 depicts a block diagram of an Internet e-commerce network including an e-commerce server 4 of a merchant company employing an embodiment of the security apparatus of the present invention.

A customer can access this e-commerce site 4 over the Internet 3 using a web browser 2 running on the customer's computer 1 or other Internet access device (such as a web-enabled cell phone or a Personal Digital Assistant (PDA)).

As depicted in FIG. 1 the e-commerce server 4 includes a web server 5 for connection to the Internet 3 to pass information to and from the Internet 3, an application server 6 connected to the web server 5 by communication layer 17 for processing information and a database 10 accessible by the application server 6. The database 10 may frequently contain important information of the merchant company. The information can include, for instance, inventory levels, customer information, supplier information, accounting information, credit card information, and other sensitive information necessary for operation of the company.

An application tool 9 (a dynamic page generator in this embodiment) at the e-commerce server site 4 is normally used to generate a dynamic web page accessible by customers over the Internet for the customers to communicate or place orders. The application server 6 would likely have a number of other application programs 7 to perform various tasks, which would be familiar to those skilled in the art, but will not be discussed herein as they are not relevant to the present invention.

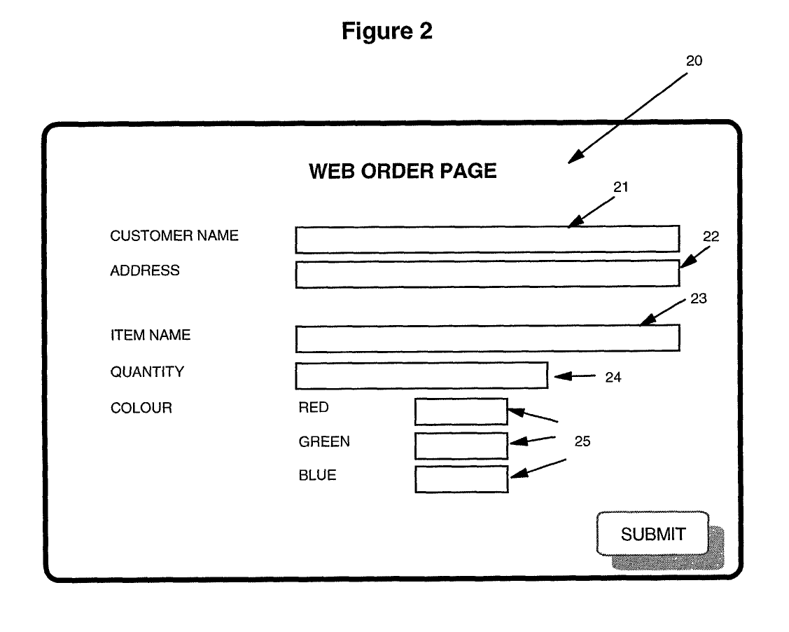

As illustrated in FIG. 2 a customer's browser causes a representation of the web page 20 to be displayed on a display of the customer's computer or web access device. The customer can enter information and make requests by inserting information into appropriate text boxes 21, 22, 23, 24 or check boxes 25 on the representation of the web page 20. When the customer is satisfied with the information inserted into the web page 20 the customer submits the information or request to the e-commerce site by pressing the submit button 26 provided on the web page 20, The browser of the customer will then generate name value pairs (NPV's) corresponding to the information and requests made by the customer to the e-commerce site 4.

Referring to FIG. 1 the web server 5 at the e-commerce site 4 passes these NPV's to the application server 6 in which one or more application tools 9 use the information contained within the NPV's in order process the submission of the customer. The processing usually requires the application server to access the database 10 associated with the e-commerce server 4.

Unscrupulous users have developed techniques of encoding unauthorized instructions into apparently normal orders and other submissions to e-commerce servers in order to access unauthorized resources or perform unauthorized or destructive tasks. This has been attempted by incorporating one or more unauthorized elements in the form of parameters, characters, or commands into information entered into text boxes or other facilities of the web page provided to a potential customer. The objective in these cases is apparently to cause messages containing unauthorized elements to be submitted to e-commerce servers to cause the unauthorized accessing of private information, or perform destructive tasks.

Relational databases, such as DB2, are usually employed by e-commerce sites to serve as the database systems. SQL statements are used to process, access, and retrieve information from many relational databases. Database management techniques including the details of SQL statement usage will not be discussed in detail herein, as these techniques are well known to those skilled in the art of database management.

Referring to FIG. 1, application tools, such as dynamic page generator 9 in application server 6 are used to process name-value pairs (NPV's) received by web server 5 from a customer's browser 2 to construct SQL statements to access information in the database 10 and generate a response which is passed to web server 5 for sending on the Internet 3 to the browser 2 on the computer 1 of a customer.

For example, in an application server using IBM Net.Commerce a dynamic page generator application tool, IBM Net.Data, is used to process information and requests submitted by the customer's browser using suitable macros (routines or programs). Execution pages are called or addressed by using URL's (Universal Record Locators). URL's will not be discussed further herein as their use and characteristics are well known by persons skilled in the Internet and networking fields. Once an execution page is called then routines (sometimes referred to as scripts, or in the case of IBM Net.Data referred to as macros) contained within the execution page are executed by the application tool (in the example the tool is IBM Net.Data).

Again referring to FIG. 1, when a submission to an e-commerce server site 4 that employs IBM Net.Commerce is made by the customer's browser 2, it is done in the form of an URL such as the following:

HTTP://Host_Name/Command/Order_Display.d2w?n1=v1&n2=v2 . . .

where

A) “Host_Name” is the name of the web server;

B) “Command” informs the application server, Net.Commerce to call an application tool, Net.Data (in this embodiment);

C) “Order_Display.d2w” is the name of the macro page to be executed by the application tool, Net.Data, the macro page contains routines used in processing;

D) data, parameters passed to Net.Data are in the form of NPV's (name value pairs);

E) “n1=v1, n2=v2” etc. are illustrations of NPV's

F) “&” is used as a separator between each of the NPV's.

The NPV's passed to the web server 5 are used by the application tool IBM Net.Data in the processing carried on by the corresponding Net.Data macro page (Order_Display.d2w). The macro page includes one or more SQL statements which are executed on the database using the NPV's.

The following is an example of a portion of a Net.Data macro from the Order_Display.d2w example page:

select orders_id, shipping_address from orders where orders_id=$(orders_id)

The parameter $(orders_id) is a variable whose value is replaced by the appropriate name-value pair received from the browser, i.e. when the Net.Data page (Order_Display.d2w) obtains the name-value pair, the value passed by the browser will substituted for $(orders_id).

For the purposes of this discussion the database in which the information is being accessed will be considered to include the following tables:

orders (which contains a list of orders that have been placed) 31;

users (which contains a list of registered users) 32.

For example, if the browser passes a name-value pair “orders_id=9”, the Net.Data page (Order_Display.d2w) will execute the query

select orders_id, shipping_address from orders where orders_id=9

There may be potential security problems in such dynamic page generator tools. An unauthorized or malicious user can seek to alter the behavior of the SQL statement in the macro by adding an illegal instruction in the form of an unexpected string (of elements, such as characters, for instance) at the end of the name-value pair. For instance, the unauthorized user can seek to get unauthorized information by passing the following name-value pairs to the e-commerce server 4:

orders_id=9 or orders_id<>9

in which case the Net.Data dynamic page generator will then attempt to execute the following SQL statement (if no sufficient security procedures are in place):

select orders_id, shipping_address from orders where orders_id=9 or orders_id<>9

This query will return information from the database on all orders that have been submitted by everyone. It can be appreciated that this would cause major concern to the database owner.

If the following name-value pairs are submitted

orders_id=9 union select users_id as order_id, password as shipping_address from users

the Net.Data dynamic page generator will attempt to execute the following SQL statement:

select orders_id, shipping_address from orders where orders_id=9 union select users_id as orders_id, password as shipping_address from users

This query would not only return the order information for the user with order id 9, but would also return all users' id's and passwords, thus compromising the security of all users using the e-commerce network.

A malicious user could seek to attack the database by passing the following name-value pair:

orders_id=9; delete from users

The Net.Data page generator will attempt to execute the following two SQL statements:

select orders_id, shipping_address from orders where orders_id=9; delete from users

Execution of the statements would destroy all the user information in the database if security procedures were not in place to prevent it.

The apparatus and method of the present invention can prevent users from obtaining unauthorized information and can protect the database from the attack of the malicious users through application tools 9, such as IBM Net.Data, Sun JSP, Microsoft ASP among others. It is also flexible enough to let the e-commerce server operators configure and control the security level of their servers.

The embodiment of the invention shown in FIG. 1 and described below uses an intermediate layer security controller 7 between the Internet users trying to access the e-commerce server 4 and application tools 9 (such as Net.Data) in the application server 6. For maximum security all access from any users to the tools should go through the security controller 7. This security controller 7 can be integrated into an e-commerce server 4 such as Net.Commerce/WCS server.

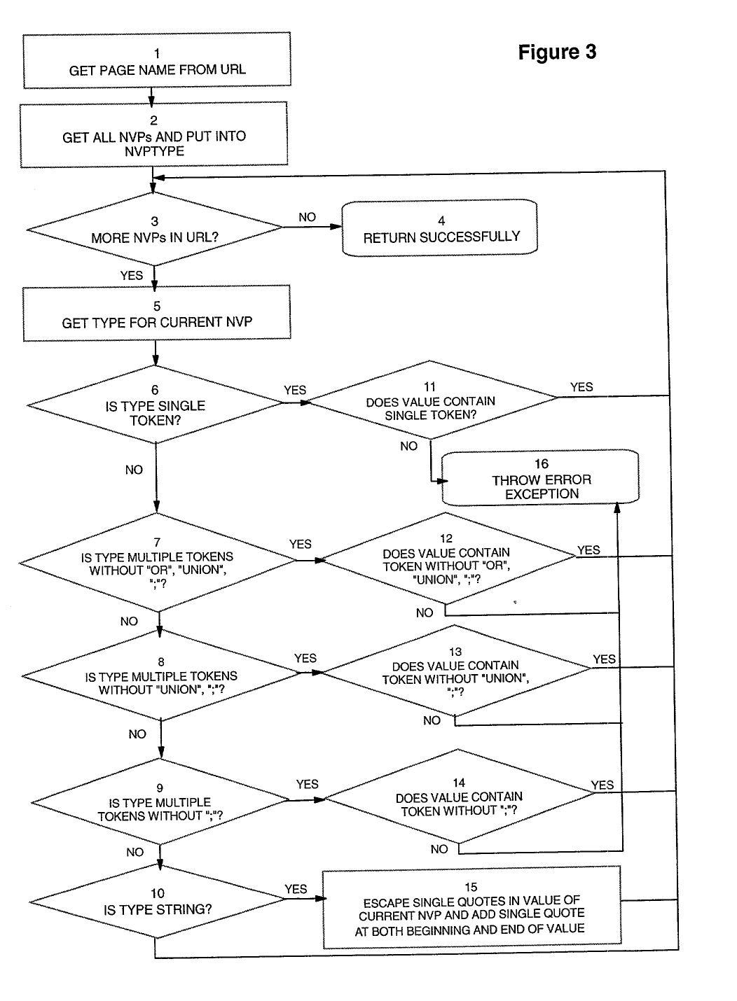

The security controller 7 and its method of operation is illustrated in the flow chart of FIG. 3 and is described below:

As was disclosed above, the browser 2 of a user attempting to access the e-commerce server 4 generates, and sends to the e-commerce server 4, name-value pairs (NPV's) for the purpose of carrying out the user's purposes.

For the purposes of this embodiment of the invention we classify each name-value pair type passed to the application tools 9 of the application server 6 of the e-commerce server 4 into one of the following security categories:

1. single token

2. string

3. multiple tokens without keywords: OR, UNION and SEMI-COLON

4. multiple tokens without keywords: UNION and SEMI-COLON

5. multiple tokens without keywords: SEMI-COLON

6. multiple tokens without restriction

A “string” is a series of any characters, including not only alphanumeric but also punctuation, or any other characters including spaces. A “token” is a string of characters without a space included in the string. For categories 3-6, the term “multiple tokens” may be interpreted as one or more tokens.

This classification gives e-commerce server administrators both security and flexibility. Depending on the security requirements for a particular web page, it can be assigned a particular security level. Security categories 1, 2, and 3 pose little risk of outside manipulation, and so can be used for most pages accessible by the general public. Security categories 4, 5 and 6 pose more risk so pages with those security categories have to be closely controlled, and are not suitable for the general public. As may be appreciated by those skilled in the art, they are designed for use by server site administrators.

For the purpose of controlling security as described above, a table—PAGENVP 11 can be created in the database to register all name-value pairs supported by respective execution pages (such as the macro pages in Net.Data) and the security categories of the NPV's, which can be cached in the security controller.

The table preferably has three columns (references to FIG. 3 are in 0):

Pagename (12)—the name of the execution page

nvp_name (13)—the name of the name-value pair

nvp_type (14)—the security category of the name-value pair

The category of the name-value pair must be one of the categories mentioned above. It is possible to let the merchant or server site administrator specify default categories to avoid registration of some/all name-value pairs of the execution pages. This may prove to be advantageous to eliminate the potential chore of registering many NPV's with the same security category. For instance it might be assumed that unless a category is specified for a nvp, that the nvp will have security category 1. We have found that most nvp's used in legitimate customer inquiries fall into categories 1 or 3.

The security controller of an embodiment of the invention uses the following algorithm to check the security of the execution pages:

1. Get the execution page name from the URL

2. Search table PAGENVP to get all name-value pairs and types for that execution page and save them in a table—NVP_TYPE

3. For every name-value pair passed from the URL to the execution page, check the table NVP_TYPE to get the corresponding type of the name-value pair.

4. If the nvp type is “single token”, make sure the value of the name-value pair only contains a single token.

5. If the nvp type is “string”, change the value of the nvp by adding a single quote at the beginning and at the end, and escape all single quotes in the string.

6. If the nvp type is “multiple tokens without keywords: OR, UNION and SEMI-COLON”, make sure there are no OR, UNION and SEMI-COLON in the value of the nvp.

7. If the nvp type is “multiple tokens without keywords: UNION and SEMI-COLON”, make sure there are no UNION and SEMI-COLON in the value of the nvp.

8. If the nvp type is “multiple tokens without keywords: SEMI-COLON”, make sure there are no SEMI-COLON in the value of the nvp.

9. If the nvp type is “multiple tokens without restriction”, no checking.

10. If any checking in steps 4-9 fails, deny the execution of the page.

Referring to FIG. 3 the method of an embodiment of the invention comprises the following steps:

(1) Get the page name of the macro page (execution page) being processed from the URL used;

(2) Get all name-value pairs and types based on page name from the database and put into a hashtable NVPTYPE

(3) Are there more name-value pairs in the URL?

(4) Return successful (security check has been completed successfully and processing of the user request by the application server can continue)

(5) Get the type for the current name-value pair using the hashtable NVPTYPE

(6) Is the type single token?

(7) Is the type multiple tokens without keywords “OR”, “UNION”, “;”?

(8) Is the type multiple tokens without keywords “UNION”, “;”?

(9) Is the type multiple tokens without keyword “;”?

(10) Is the type string?

(11) Does the value of the current name-value pair contain a single token?

(12) Does the value of the current name-value pair contain one or more tokens without keywords “OR”, “UNION”, “;”?

(13) Does the value of the current name-value pair contain one or more tokens without keywords “UNION”, “;”?

(14) Does the value of the current name-value pair contain one or more tokens without keyword “;”?

(15) Escape all single quotes in the value of the current name-value pair and add a single quote at both the beginning and the end of the value

(16) Throw error exception (security check has failed, error message or page is returned to user's browser)

An example of pseudo code used to implement the above security check method of the invention is listed below:

SecurityCheck( ) {

get the execution page name from the URL;

get all name value pairs and type based on execution page name from database and put into hashtable nvptype;

for (each name value pair passed from the URL)

{

get the corresponding type from hashtable nvptype and put into type;

if ((type is single token) && (value contains more than one token))

{

throw error exception;

}

else if ((type is multiple token without OR, UNION, and SEMI-COLON) && (value contains OR, UNION or SEMI-COLON))

{

throw error exception;

}

else if ((type is multiple token without UNION and SEMI-COLON) && (value contains UNION or SEMI-COLON))

{

throw error exception;

}

else if ((type is multiple token without SEMI-COLON) && (value contains SEMI-COLON))

{

throw error exception;

}

else if (type is string)

{

escape all single quotes in the value;

add single quote at the begin and the end of the value;

}

}

//security check passed return successfully;

}

While this invention has been described in relation to preferred embodiments, it will be understood by those skilled in the art that changes in the details of construction, arrangement of parts, compositions, processes, structures and materials selection may be made without departing from the spirit and scope of this invention. Many modifications and variations are possible in light of the above teaching. Thus, it should be understood that the above described embodiments have been provided by way of example rather than as a limitation and that the specification and drawings are, accordingly, to be regarded in an illustrative rather than a restrictive sense.

What is claimed is:

1. A method of protecting security of a network server from unauthorized content contained in a message received by said server from a user, comprising:
intercepting said message before any content of said message is processed by said server;
examining said message to determine if it contains one or more unauthorized elements;
if it is determined that said message contains an unauthorized element preventing said message received from being processed by said server;
if it is determined that said message does not contain an unauthorized element allowing said message received to be processed by said server.

2. The method of claim 1 wherein, if it is determined that said message received contains an unauthorized element, preventing said message received from being processed by said server, and causing an error notification to be sent to said user.

3. The method of claim 1 comprising:
receiving identification of an execution program set to be used to process said message received;
retrieving identification of all message types associated with said execution program set;
examining said message received by said server in relation to said message types associated with said execution program set;
determining if said message received by said server contains an unauthorized element in relation to the corresponding message type for said message received;
preventing a said message received containing an unauthorized element from being processed by said server.

4. The method of claim 3 wherein, if it is determined that said message received contains an unauthorized element, causing an error notification to be sent to said user.

5. A method of protecting security of an Internet network server from unauthorized content contained in a message received over the Internet by said server from a user, comprising:
intercepting said message before any content of said message is processed by said server;
examining said message to determine if it contains one or more unauthorized elements;
if it is determined that said message contains an unauthorized element, preventing said message received from being processed by said server;
if it is determined that said message received does not contain an unauthorized element, allowing said message received to be processed by said server.

6. The method of claim 5 wherein, if it is determined that said message received contains an unauthorized element preventing said message received from being processed by said server, causing an error notification to be sent to said user.

7. The method of claim 5 comprising:
receiving identification of an execution page to be used to process said message received;
retrieving identification of all message types associated with said execution page;
examining said message received by said server in relation to said message types associated with said execution page;
determining if said message received by said server contains an unauthorized element in relation to a corresponding message type for said message received;
preventing said message received containing an unauthorized element from being processed by said server.

8. The method of claim 7 wherein, if it is determined that said message received contains an unauthorized element, causing an error notification to be sent to said user.

9. The method of claim 8 wherein, if it is determined that said message received does not contain an unauthorized element, allowing said message received to be processed by said server.

10. The method of claims 1, 5, or 7 wherein said message comprises a name-value pair.

11. The method of claim 10 wherein said element comprises one or more of the following items: an instruction, a command, a character, a parameter, a token, or a string of any of said previous items.

12. The method of claims 11 wherein said element is interpretable as an instruction or command by said server.

13. Security control apparatus for controlling the security of a network server from unauthorized content contained in a message received from a user of said server comprising:
means for intercepting said message received before any content of said message is processed by said server;
means for examining said message received to determine if it contains one or more unauthorized elements;
means for preventing said message received from being processed by said server if it is determined that said message received contains an unauthorized element;
means for allowing said message received to be processed by said server if it is determined that said message received does not contain an unauthorized element.

14. The apparatus of claim 14 wherein said network server comprises an Internet network server and said message is received over the Internet by said server from a user.

15. The apparatus of claim 13 or 14 further comprising means for returning an error message to said user.

16. The apparatus of claim 15, comprising:
means for receiving identification from said user of an execution page retrievable by said server to be used to process said message received;
means for retrieving identification of message types associated with said execution page from facilities associated with said server;
means for examining said message received by said server in relation to said message types associated with said execution page;
means for determining if said message received by said server contains an unauthorized element in relation to a corresponding message type for said message received;
means for preventing said message received containing an unauthorized element from being processed by said server.

17. The apparatus of claim 16 comprising means for allowing said message received to be processed by said server if it is determined that said message received does not contain an unauthorized element.

18. The apparatus of claim 17 wherein said message comprises a name-value pair and said element is contained by said name-value pair.

19. The apparatus of claim 18 wherein said element comprises one or more of the following items: an instruction, a command, a character, a parameter, a token, or a string of any of said previous items.

20. The apparatus of claim 19 wherein said element is interpretable as an instruction or command by said server.
